(19) United States
(12) Patent Application Publication
(10) Pub. No.: US 2008/0056714 A1
(43) Pub. Date: Mar. 6, 2008

(54) Method and Apparatus for Obtaining an Optical Power Level in a Pon Network

(76) Inventor: Todd Arthur Konstan, Casselberry, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/631,023

(22) PCT Filed: Jun. 29, 2005
(86) PCT No.: PCT/EP05/53064

§ 371 Date: Dec. 28, 2006

Related U.S. Application Data
(60) Provisional application No. 60/584,354, filed on Jun. 30, 2004.

(51) Int. Cl. H04B 17/00; H04B 10/08

(52) U.S. Cl. 398/38

(57) ABSTRACT

A method and apparatus for remotely obtaining an optical power level in a PON network is provided. An Element Management System (EMS) transmits a Simple Network Management Protocol (SNMP) request message to retrieve an optical power level from an Optical Network Unit (ONU). After receiving the SNMP request message, an Optical Line Terminal (OLT) sends an optical power level request frame to the ONU. The ONU responds to the request with an optical power level response frame having an expected bit pattern that is used by an optics block in the OLT to calculate the upstream optical power level. The OLT sends the calculated level to the EMS in a SNMP response message.

### CROSS-REFERENCE TO RELATED APPLICATIONS

The present application claims the benefit of the provisional patent application filed on Jun. 30, 2004, and assigned application number 60/584,354.

### FIELD OF THE INVENTION

The present invention relates to a method and apparatus for obtaining an optical power level in a Passive Optical Network (PON), and more particularly, to modifying a PON to remotely obtain the upstream optical power level in an Optical Network Unit.

### BACKGROUND

A Passive Optical Network (PON) includes the fiber optical cables to provide multiple data transmission paths capable of delivering high-bandwidth data services to multiple users. A data transmission path may need to be monitored for power strength during equipment installation, service activation and operation of the network. As is known, monitoring the data transmission path from the user toward the PON network requires a tester travel to the user's location and to transport the test equipment. However, a shortcoming is this method can be time consuming and costly especially if the tester needs to test data transmission paths for users remotely located. Additionally, it may be difficult or dangerous for the tester to hook up and use the test equipment, such as the tester having to climb a telephone pole. Therefore, there exists a need to provide an improved way to test the data transmission path from a user toward the PON network.

### SUMMARY OF THE INVENTION

An aspect of the present invention involves a method for determining an upstream optical power level of an Optical Network Unit (ONU), comprising sending a request frame to the ONU requesting the ONU upstream optical power level by an Optical Line Terminal (OLT), receiving the request frame by the ONU, sending a response frame from the ONU, the response including an expected bit pattern, and determining an upstream optical power level value based on the expected bit pattern.

Another aspect of the present invention involves a management system adapted to request an optical power level of an optical device, comprising a processing unit, an input interface adapted to accept a request to remotely retrieve an optical power level, a transceiver for sending and receiving messages to and from a network element, and an output interface adapted to display the requested optical power level.

Another aspect of the present invention involves a network element within a Passive Optical Network (PON) adapted to provide an upstream optical power level for an optical device, comprising a transceiver for receiving a request message from a management system and sending a response message to the management system, an optical power level managed entity including optical power level attribute, the optical power level managed entity facilitating the processing a optical power level request message from the management system, and a processing unit adapted to process a optical power level request message.

Yet another aspect of the present invention optical device within a Passive Optical Network (PON) adapted to provide an optical power level, comprising an optics block for sending and receiving transmissions to and from a PON network, a media access control providing a physical address to the PON network and for determining if the received transmission is for the optical device, and a processing unit adapted to receive an optical power level transmission request.

### BRIEF DESCRIPTION OF THE DRAWINGS

The above mentioned and other concepts of the present invention will now be described with reference to the drawings of the exemplary and preferred embodiments of the present invention. The illustrated embodiments are intended to illustrate, but not to limit the invention. The drawings contain the following figures, in which like numbers refer to like parts throughout the description and drawings wherein:

FIG. 1 illustrates an exemplary prior art schematic diagram of a Gigabit Passive Optical Network (GPON);

FIG. 2 illustrates an exemplary prior art schematic diagram of a method for obtaining an upstream optical power level of an Optical Network Unit (ONU) within a GPON;

FIG. 3 illustrates an exemplary schematic diagram of a method and apparatus of the present invention for obtaining an upstream optical power level of an ONU within a GPON; and

FIG. 4 illustrates an exemplary message flow of a method and apparatus of the present invention for obtaining an upstream optical power level of an ONU within a GPON.

### DETAILED DESCRIPTION OF THE INVENTION

The invention described herein may employ one or more of the following concepts. For example, one concept relates to remotely obtaining an optical power level. Another concept relates to modifying a management system. Another concept relates to modifying an optical device. Yet another concept relates to modifying a network element.

The present invention is disclosed in context of obtaining an upstream optical power level of an Optical Network Unit (ONU) within a Gigabit Passive Optical Network (GPON) via an Element Management System (EMS) using a Simple Network Management Protocol (SNMP). The principles of the present invention, however, are not limited to use within a GPON but may be applied to other Passive Optical Networks (PONs) such as a Broadband Passive Optical Network (BPON). While the present invention is described in context of obtaining an upstream optical power level of an ONU, an optical power level may be obtained on an optical device other than the ONU such as an Optical Network Terminal (ONT) or any other suitable optical device capable of sending and/or receiving optical transmissions. The invention may also be applied to obtaining a downstream optical power level. Additionally, while the present invention is disclosed in context of an EMS, other management systems that manage network elements such as an Optical Line Terminal (OLT) may be used, for example a network management system may be used. Also, while management request messages are described as SNMP request messages and management response messages are described as SNMP response messages other network management protocols, such as Transaction Management 1 (TL1), and Common Management Information Protocol (CMIP), may be used. One skilled in the art may find additional application for the apparatus, processes, systems, components, configurations, methods and applications disclosed herein. Thus, the illustration and description of the present invention in context of obtaining an upstream optical power level of an ONU within a GPON via the EMS using SNMP is merely one possible application of the present invention. However, the present invention has particular applicability for use for obtaining an upstream optical power level of an ONU within a GPON via the EMS using SNMP.

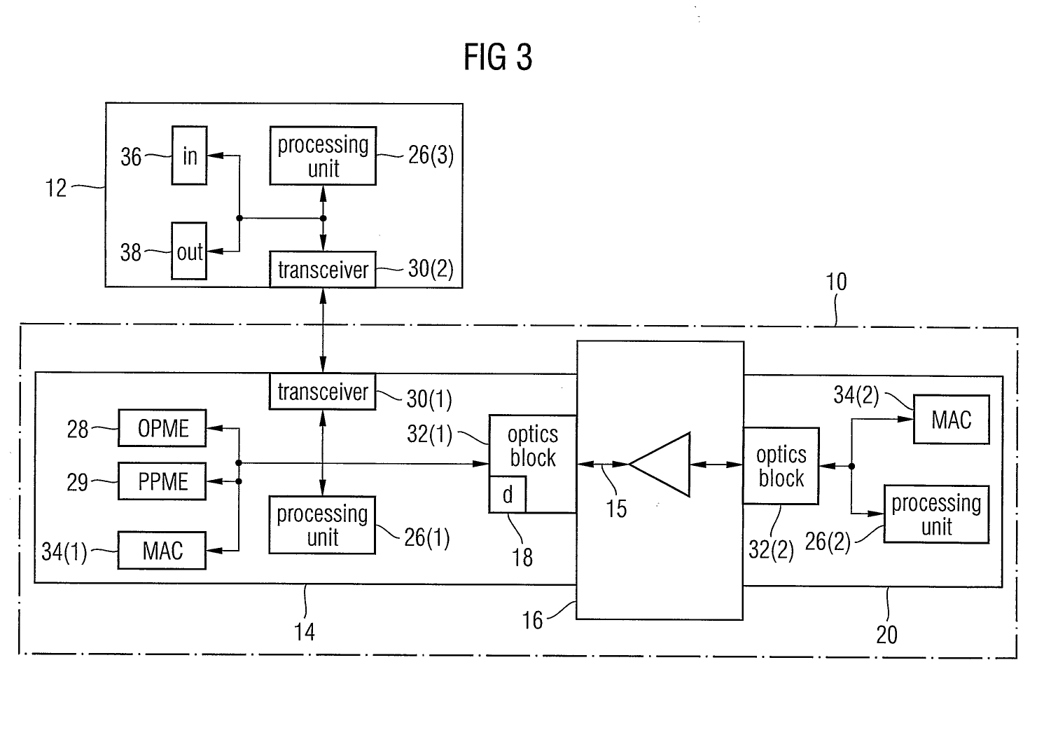

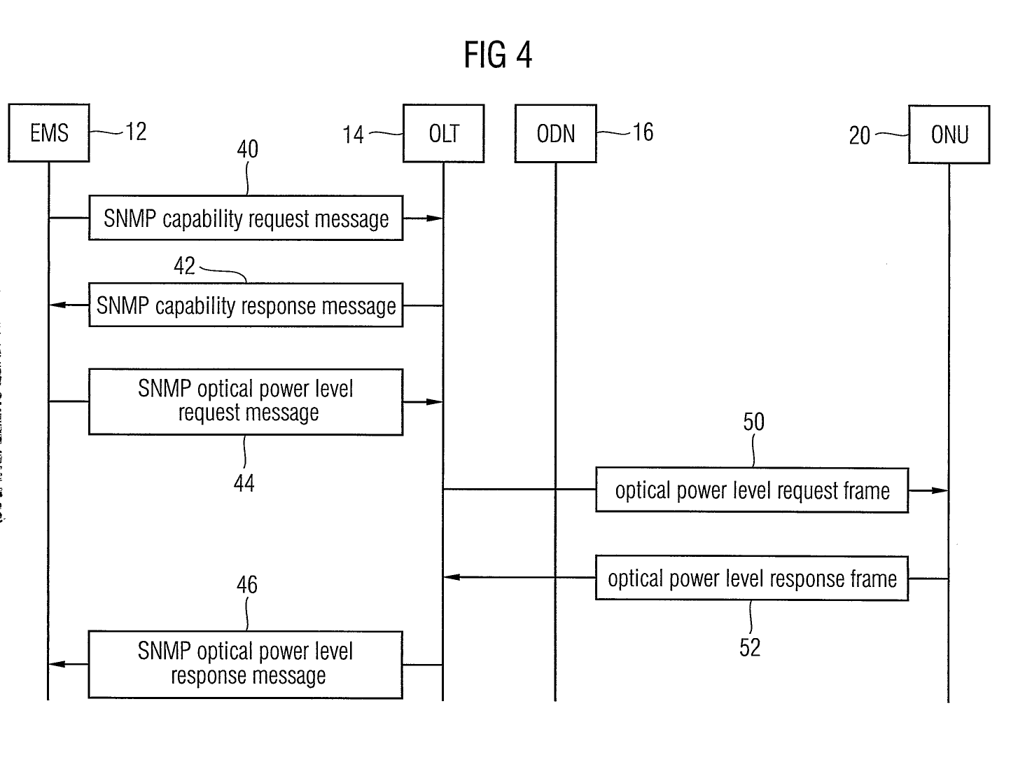

Referring to FIGS. 3 and 4, an exemplary schematic diagram of a method and apparatus is provided. An EMS 12 transmits a SNMP request message 44 to retrieve an optical power level from an ONU 20. After receiving the SNMP request message 44, an OLT sends a request frame 50 to the ONU 20. The ONU 20 responds with response frame 52 having an expected bit pattern that is used by an optics block 32(1) in the OLT 14 to calculate the upstream optical power level. The level is then sent to the EMS 12 in a SNMP response message 46.

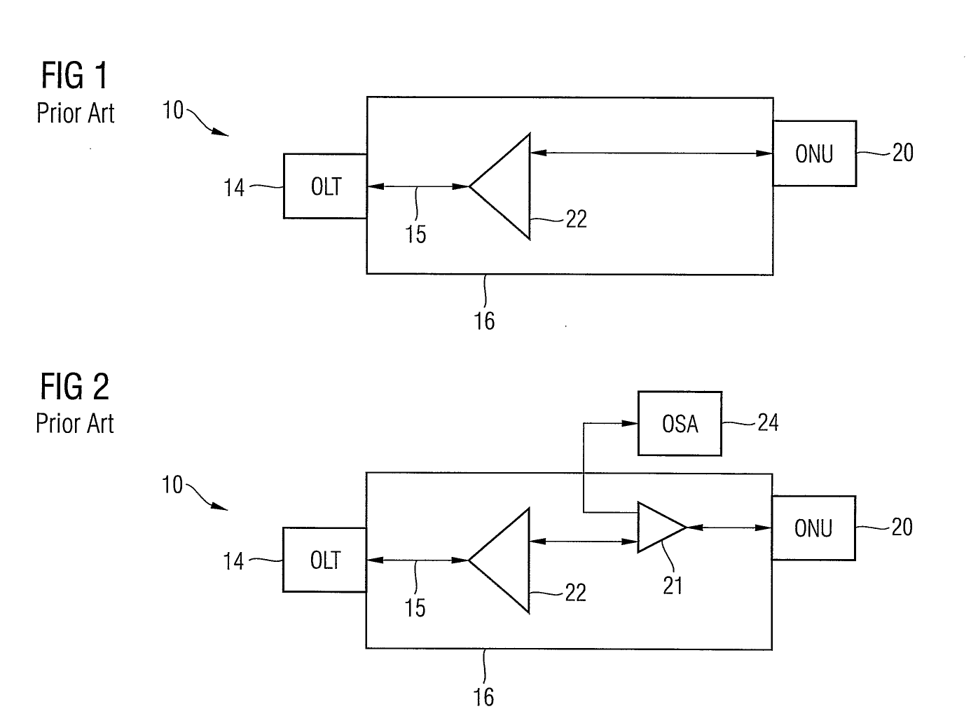

FIG. 1, a prior art schematic diagram of a GPON 10 is shown. The GPON 10 includes an OLT 14 having a communication link to an ONU 20 via an Optical Distribution Network (ODN) 16. The communications link between the OLT 14 and ONU 20 provides a bi-directional communications path. A physical path 15 operatively connects the OLT 14 to the ODN 16. For simplicity, a single ODN 16 and a single ONU 20 are shown. However, multiple ODNs 16 may be operatively connected to the OLT 14 via separate physical paths. In addition, multiple ONUs 20 may be operatively connected to the ODN 16. The term “communication link” refers herein to any suitable wireless, wireline, electrical, and/or optical based system that supports communication between network elements using ground-based and/or space-based components.

The OLT 14 provides a downstream transmission towards the ONU 20. Voice and data are transmitted downstream preferably within a 1490 nm wavelength band. Additionally, the OLT 14 may transmit multimedia and video signals downstream preferably within a 1550 nm wavelength band. Downstream transmission from the OLT 14 is in a continuous mode and the transmitted signal is broadcasted to each ONU 20 that is operatively connected to the OLT 14 providing a point-to multipoint communication. Continuous mode refers to not having to share the downstream transmission of a transmission link with another device. In addition, the OLT 14 receives upstream signals from the ONU 20.

The ONU 20 provides the upstream transmission towards the OLT 14. Voice and data are transmitted upstream preferably within a 1310 nm wavelength band. Upstream transmission from the ONU 20 is in a burst mode. Burst mode refers to the ONU 20 having a certain allocated time to transmit a signal so that signals from each ONU 20 do not collide with each other. ONU 20 refers to any suitable device such as an ONU 20 or ONT capable of sending and/or receiving optical transmissions. In addition, the ONU 20 receives downstream transmissions from the OLT 14.

The ODN 16 includes passive components such as optical fibers, connectors, and passive splitters 22 for directing transmission propagating between an OLT 14 and a plurality of ONUs 20.

As described above the illustrated embodiment uses a point-to-multipoint communication. However, the principles of the present invention may be applied to a point-to-point communication.

Referring now to FIG. 2, a prior art schematic diagram of a method for obtaining an upstream optical power level of an ONU 20 within a GPON 10 is shown. In addition to the GPON having the OLT 14, ODN 16 and ONU 20, the GPON 10 includes a splitter 21 and an Optical Spectrum Analyzer (OSA) 24. The splitter 21 allows an optical transmission from the ONU 20 to be split between the ODN 16 and the OSA 24 in such a way as to not unsuitably degrade the signal to the ODN 16, such as a 99 to 1 ratio. The OSA uses the signal it receives to obtain the optical power level of the upstream transmission from the ONU 20.

Referring now to FIG. 3, a schematic diagram of a method and apparatus of the present invention for obtaining an upstream optical power level of an ONU 20 within a GPON is provided. The illustration includes an EMS 12 having a communication link to the GPON that includes an OLT 14, ODN 16, and ONU 20.

In an exemplary embodiment as illustrated in FIG. 3, the EMS 12 is adapted to manage the OLT 14 for remotely obtaining an optical power level for the ONU 20. The EMS 12 may include a transceiver 30(2), an input interface 36, an output interface 38, and a processing unit 26(3). Transmission between the EMS 12 and the OLT 14 is handled by the transceiver 30(2). Input from a Graphical User Interface (GUI), a signal from another device, or any suitable method to collect input requests is received by the input interface 36. The input interface 36 is adapted to accept a request to remotely retrieve an optical power level. The output interface 38 outputs results to the GUI, to another device, or any suitable method for providing output results. The output interface 38 is adapted to output the requested optical power level value. The processing unit 26(3) is adapted to include the hardware and/or software that may be needed to process the optical power level requests from the input device and to process the optical level output to the output device. Additionally, the processing unit 26(3) is adapted to process SNMP messages communicating requests and responses related to the optical power level as described in further detail below.

Still referring to FIG. 3, an exemplary embodiment of the OLT 14 is adapted to remotely obtain an optical power level on an ONU 20 after receiving an SNMP request from the EMS 12. The OLT 14 may include a transceiver 30(1), an optics block 32(1), a Media Access Control (MAC) 34(1), an optical power managed entity 28, a physical path managed entity 29, and a processing unit 26(1). Transmission between the OLT 14 and the management is handled by the transceiver 30(1). The optics block 32(1) includes software and/or hardware to provide transmission between the OLT 14 and the ONU 20. The optics block 32(1) is adapted to determine the value of the optical power level as described in further detail below. The MAC 32(1) serves as a media access control and may be adapted to facilitate message processing used for remotely obtaining the optical power level. The optical power managed entity 28 manages optical power processing and includes an optical power level attribute to facilitate the remote access of the optical power level. The physical path managed entity 29 describes the characteristics of the physical connection between the OLT 14 and the ODN 16. The physical path managed entity 29 may be adapted to include a capability attribute to indicate if the ODN 16 and/or ONU 20 has remote optical power level capabilities as described in further detail below. The processing unit 26(1) includes the hardware and/or software needed for communication and/or managed entity processing.

In the exemplary embodiment illustrated in FIG. 3, the ONU 20 is adapted to supply an expected bit pattern to the OLT 14 as described in further detail below. The ONU 20 may include an optics block 32(2), a MAC 34(2), and a processing unit 26(2). Transmission between the ONU 20 and the OLT 14 is handled by the optics block 32(2). The MAC 34(2) serves as a media access control and filters downstream traffic not meant for the ONU 20. The processing unit 26(2) includes the hardware and/or software needed for communication processing.

Referring now to FIGS. 3 and 4 an exemplary message flow of a method and apparatus of the present invention for obtaining an upstream optical power level of an ONU 20 within a GPON is shown. After receiving a request to remotely retrieve an optical power level, the EMS 12 creates a SNMP capability request message 40 to get the capability of an ONU 20 via the physical path managed entity 29. The EMS 12 then sends the SNMP capability request message 40 to the OLT 14. The OLT 14 receives the SNMP capability request message 40 and uses the physical path managed entity 29 to determine if the ONU 20 is capable of having the optical power level obtained remotely. The OLT 14 then returns the capability result in a SNMP capability response message 42.

When the ONU 20 is capable of having the optical power level obtained remotely, the EMS 12 creates a SNMP optical power level request message 44 to get the optical power level via the optical power managed entity 28. The SNMP optical power level request message 44 is then sent to the OLT 14. The OLT 14 receives the SNMP optical power level request message 44 and formats a frame 50 requesting an upstream optical power level. In one embodiment, the optical power request frame 50 includes a field in a Physical Control Block downstream (PCBd) indicating the request for the upstream optical power level. In another embodiment, the PCBd includes a transmission convergence bandwidth subfield indicating the request for the upstream optical power level. However, those skilled in the art would recognize that other indicators in the optical power request frame 50 may be used to indicate the request for the upstream optical power level. The optical power request frame 50 is transmitted by the optics block 32(1) toward the ONU 20 via the ODN 16.

After the ONU 20 determines the optical power level request frame 50 received is meant for the ONU 20, the ONU 20 responds with an optical power level response frame 52 having an expected bit pattern. The optical power level response frame 52 may also include a power leveling sequencing upstream (PLSu) field. The expected bit pattern is a bit pattern that the OLT 14 will recognize as an optical power level response frame 52. The expected bit pattern may be negotiated between to OLT 14 and the ONU 20, predefined, and/or administered.

When the optics block 32(1) of the OLT 14 recognizes the expected bit pattern of the optical power level response frame 52, the optics block 32(1) determines the optical power level value by calculating the average power of the PLSu. In response to an incident optical power, a detector device 18 within the optics block 32(1) creates an electrical current. A numerical value of the electrical current is provided. The detector device 18 has a known characteristic of Responsivity (R) that is the ratio of the electrical current to the optical power level and is expressed in amperes/watt. By knowing an R value of a specific optical wavelength for the detector device 18 and the numerical value of the electrical current, the input optical power can be calculated. The optical power level may, however, be recognized and/or determined by a device other than the optics block 32(1). Additionally, the average optical power may be extended to the process of performing multiple requests 50 and receiving multiple responses 52 and then averaging their results. A SNMP optical response message 46 including the calculated upstream optical power level value is sent to the EMS 12. The EMS 12 displays this value.

In some cases the ONU 20 may be in a state that it is unable respond. The ONU 20 advantageously responds in power-setup, serial-number, ranging, and operation states. However, since the ONU 20 may be unable to respond, it may be desirable to resend the optical power level frame request by the OLT 14 after a time period, e.g. a predetermined time period. The OLT 14 may also resend for a certain number of times, e.g. a predetermined number of times, or during on overall time period, e.g. a predetermined overall time period.

The illustrated embodiment of the present invention uses a SNMP capability messaging sequence 40, 42 and a physical path managed entity 29 to determine if the ONU 20 is capable of obtaining the optical value remotely. However, an alternative suitable messaging sequence and/or managed entity may be used to determine this capability. Furthermore, the capability check may be skipped all together.

The invention may be embodied in many different forms and may be applied to many different types of networks, protocols, and protocol versions and should not be construed as limited to the embodiments set forth herein. Rather, these embodiments are provided so that this disclosure will be thorough and complete, and will fully convey the scope of the invention to those skilled in the art. Thus, the scope of the invention should be determined based upon the appended claims and their legal equivalents, rather than the specific embodiments described above.

1. A method for determining an upstream optical power level of an Optical Network Unit (ONU), comprising:
sending a request frame to the ONU requesting the ONU upstream optical power level by an Optical Line Terminal (OLT);
receiving the request frame by the ONU;
sending a response frame from the ONU, the response frame including an expected bit pattern; and
determining an upstream optical power level value based on the expected bit pattern.

2. The method according to claim 1, further comprising sending a Simple Network Management Protocol (SNMP) optical power level message prior to the step of sending the request frame.

3. The method according to claim 2, further comprising:
sending a SNMP capability message from a management system,
receiving the SNMP capability message by the OLT,
sending a SNMP capability response to the management system, and
if the response indicates optical power level is not supported, then skipping the steps of:
sending the request frame,
receiving the request frame,
sending the response frame, and
determining the upstream optical power level value.

4. The method according to claim 2, further comprising responding to the SNMP optical power level request message by sending an SNMP optical power level response message that includes the upstream optical power level value.

5. The method according to claim 4, further comprising displaying the optical power level value by the management system.

6. A management system adapted to request an optical power level of an optical device in a Passive Optical Network (PON), comprising:
a processing unit;
an input interface adapted to accept a request to remotely retrieve an optical power level;
a transceiver for sending and receiving messages to and from a network element; and
an output interface adapted to display the requested optical power level.

7. The management system according to claim 6, wherein the management system is selected from the group consisting of an Element Management System and a Network Management System.

8. The management system according to claim 6, wherein the optical device is selected from the group consisting of an Optical Network Unit and an Optical Network Terminal, and the network element is an Optical Line Terminal.

9. The management system according to claim 6, wherein the management system is adapted to send an optical power level request message to the network element and to receive an optical power level response message from the network element.

10. The management system according to claim 9, wherein the output interface is adapted to display an optical power level value obtained from the optical signal level response message.

11. A network element within a Passive Optical Network (PON) adapted to provide an upstream optical power level for a optical device, comprising,
a transceiver for receiving a request message from a management system and sending a response message to the management system;
an optical power level managed entity including an optical power level attribute, the optical power level managed entity facilitating processing of an optical power level request message from the management system; and
a processing unit adapted to process the optical power level request message.

12. The network element according to claim 11, wherein the network element is an Optical Line Terminal.

13. The network element according to claim 11, wherein the management system is selected from the group consisting of an Element Management System and a Network Management System and wherein the management system messages are formatted according to a Simple Network Management Protocol.

14. The network element according to claim 11, wherein the network element is further adapted to send a frame to the optical device after receiving a retrieve optical power level request message from the management system, the frame requesting an upstream optical power level.

15. The network element according to claim 14, wherein the network element is further adapted to resend the frame to the optical device if no response is received from the optical device within a time frame.

16. The network element according to claim 11, wherein the network element is further adapted to recognize an expected bit pattern in a power leveling sequencing upstream field in a frame received from the optical device.

17. The network element according to claim 16, further comprises an optics block adapted to recognize the expected bit pattern.

18. The network element according to claim 16, wherein the network element is further adapted to obtain an optical power level value by calculating an average power for the power leveling sequencing upstream field in the frame received from the optical device.

19. The network element according to claim 18, further comprises an optics block adapted to calculate the average power.

20. The network element according to claim 18, wherein the network element is further adapted to send a response of the optical power level request message to the management system, the response message including the optical power level value.

21. The network element according to claim 20, wherein the managed entity includes an optical power level attribute.

22. An optical device within a Passive Optical Network (PON) adapted to provide an optical power level, comprising:
an optics block for sending and receiving transmissions to and from a PON network;
a media access control providing a physical address to the PON network and for determining if the received transmission is for the optical device; and
a processing unit adapted to receive an optical power level transmission request.

23. The optical device according to claim 22, wherein the optical device is selected from the group consisting of an Optical Network Unit and an Optical Network Terminal.

24. The optical device according to claim 22, wherein the received transmission includes a physical control block downstream field, the downstream field having a subfield that indicates if the received transmission is the optical power level transmission request.

25. The optical device according to claim 24, wherein the subfield is within a transmission convergence bandwidth field.

26. The optical device according to claim 22, wherein the processing unit is further adapted to respond to the optical power level transmission request with an expected bit pattern.

27. The optical device according to claim 26, wherein the processing unit is further adapted to respond to the optical power level transmission request when the optical device is in a state selected from the group consisting of power-setup, serial-number, ranging, and operation.
